(19) United States
(12) Patent Application Publication
(10) Pub. No.: US 2004/0156750 A1
(43) Pub. Date: Aug. 12, 2004

(54) Device for performing catalytic screening

(76) Inventors: Wolfram Stichert, Heidelberg (DE); Jens Klein, Heidelberg (DE); Mario Hermann, Laudenbach (DE); Stephan A. Schunk, Heidelberg (DE); Wolfgang Strehlau, Dossenheim (DE)

Correspondence Address: KEIL & WEINKAUF, 1350 CONNECTICUT AVENUE, N.W., WASHINGTON, DC, 20036, US

(21) Appl. No.: 10/482,225

(22) PCT Filed: Jun. 14, 2002
(86) PCT No.: PCT/EP02/06626

(30) Foreign Application Priority Data
Jul. 4, 2001 (DE) 101 32 252.6

(51) Int. Cl. B01J 19/00

(52) U.S. Cl. 422/99; 422/130

(57) ABSTRACT

The subject invention relates to a device (10), in particular for performing catalytic screening with a reactor element (16), containing at least one gas inlet port (18) and a plurality of channels (42,44) as well as a plurality of reaction chambers (46) that are connected to the channels (42,44), characterized in that the channels (42,44) form an angle not equal to zero degrees with the, at least one, gas inlet port (18).

The present invention relates to a device for performing catalytic screening, in particular to a reactor for the high throughput screening of catalysts that is able to support the application of several (at least two) methods of analysis, such as integral (e.g. optical) methods of analysis and at least one additional method, such as spectrometric methods of analysis (e.g. mass spectrometry), preferably in parallel or in rapid sequence.

Due to their design, the reactors known so far from the prior-art are only suited to measure with one method of analysis, either IR-thermography or, e.g., mass spectrometry.

A reactor for the IR-thermography screening of heterogeneous catalysts is described in WO 97/32208. This reactor contains a sapphire window in the cover that allows for simultaneously observing by thermography, in this case, 16 catalysts. The educt gas is dosed in via four gas inlet ports that are arranged symmetrically near the bottom. The four gas outlet ports are arranged in a similar way and are positioned close to the cover. The catalysts are placed approximately half way between gas inlet and outlet and are arranged in an accessible manner on an aluminum oxide disk. This reactor is not suited for the application of methods of analysis other than thermography because the products emerging from the individual catalysts cannot be collected and analyzed selectively. Furthermore, the flow conditions for each individual catalyst pellet are not defined sufficiently as to allow for a detailed analysis of the activity profile of the catalysts. Also, the aluminum oxide disk used for supporting all catalyst pellets is not optimized with respect to heat emissivity. Small differences in temperature cannot be detected due to the differences in emissivity. Therefore, the scope of application for this type of reactor remains restricted to reactions that are strongly exothermic, such as oxyhydrogen-type reactions. Finally, explosions are possible, in particular in the case of potentially explosive mixtures, due to the relatively large gas volume.

The DE 198 09 477 A1 describes a reactor that is used for screening heterogeneous catalysts under high throughput conditions. The catalysts are present in separate channels that are arranged in the form of a matrix and are simultaneously exposed to the reaction gas. A central gas inlet port for all reaction channels is located at the top on the cover of the reactor and the exhaust from each reaction channel is separately guided to the bottom of the reactor where it can be accessed and analyzed selectively.

This reactor model is suited to screen heterogeneous catalyst at a high throughput rate with methods of analysis, such as gas chromatography, mass spectrometry and other known spectroscopic methods. However, this reactor is not suited for performing thermography since the thermal radiation of the catalysts cannot be detected from the outside.

The WO 99/34206 relates to a reactor that is similar to the one described in WO 97/32208. Gas supply and gas exhaust take place from the side. Detection of thermal radiation emanating from the catalyst pellets is possible by means of a suited window in the cover. Slate is used as the substrate material for all catalysts in this case.

However, in this case, too, selective analysis of the products generated by a specific catalyst is not possible. Similarly, the flow conditions around the catalyst material are not defined in this case as well.

A monolithic parallel reactor for the automated screening of heterogeneous catalysts is described in U.S. Pat. No. 4,099,923. The reactor consists of six conventional test tubes. These tubes are charged with reaction gas in an automated manner and in sequence. The tubes display a common gas exhaust over which the product gas is guided towards the online analysis system. Only one catalyst at a time can be exposed to the educt gas due to the concept of a gas inlet port. Therefore, this embodiment is not suited for catalysts that display a period of formation. Furthermore, this embodiment only allows for employing conventional valve switches.

The DE-A 27 14 939 relates to an industrial-scale tubular bundle reactor with modified gas exhaust ports. With these ports, it is possible to selectively analyze the product gas flowing away from a specific tube. However, due to the large amount of catalyst material, this type of reactor is not suited for the rapid screening of catalysts. Foremost, this embodiment is suited for quality control only. Furthermore, this embodiment does not allow for precisely controlling the temperature or for employing thermography.

A reactor set-up with 7 to 10 parallel channels that are heated by an external furnace is described in the DE-A 234 941. However, this application is only suited for reactions with a low heat of reaction and is not suited for employing IRthermography.

A six-way micro-reactor is described by J. G. Creer in Appl. Catal. 22 (1986), 85. The reactor consists of two reactor blocks with each of the six channels having a diameter of 6 mm. The exhaust gas flow from each channel can be analyzed separately by means of gas chromatography. However, the use of IR-thermography is not possible in this set-up either.

In summary, the reactors disclosed so far are only capable of measuring with one method of analysis at most, either with thermography or with, e.g., mass spectrometry.

A device for the combinatorial production and screening of libraries of materials under application of at least two methods of analysis is described in the application DE-A 100 12 847.5-52, however, only in general terms. The methods of measurement applied for analysis in the aforementioned application are, preferably, IR-thermography in combination with, e.g., mass spectrometry, gas chromatography or other methods of spectroscopy.

In light of the aforedescribed prior-art, the object of the present invention was to provide an improved device that is suited, among others, to screen catalysts by using a combination of a plurality of methods of analysis.

A further object of the present invention was to optimize the gas supply of such a device with respect to high throughput screening of catalysts and to thereby facilitate, among other things, access to the modules to be investigated, e.g. catalyst probes, preferably under reaction conditions and for multiple, preferably different, systems of analysis.

These and other tasks are solved, according to the invention, by a device that is suited, in particular, for performing catalytic screening with a reactor element that contains at least one gas inlet port and a plurality of channels, as well as a plurality of reaction chambers that are interconnected by channels, characterized in that these channels form an angle not equal to zero degrees with the, at least one, gas inlet port.

The reactor element whose outer shape is, in principle, not restricted in any way may be realized, e.g., in the shape of a disk. No restrictions are specified with respect to the material to be used for the reactor element according to the invention, so long as the materials chosen are able to withstand the stress that is imposed on the reactor element. Preferably, metals or metallic alloys are employed, such as brass, aluminum and stainless steel as defined in, e.g., DIN 14401, DIN 14435, DIN 14541, DIN 14571, DIN 14573, DIN 14575, DIN 24360/24366, DIN 24615/24617, DIN 24800/24810, DIN 24816, DIN 24851, DIN 24856, DIN 24858, DIN 14767, DIN 24610, DIN 14765, DIN 14847, DIN 14301, as well as ceramic materials. Particularly preferred, the reactor element is made of V2A or V4A steel. The reactor element may contain recesses that correspond to the optional clamping elements in number, shape and orientation. In addition to these recesses, further recesses are machined into the reactor element, preferably realized as borings. By means of these borings it is possible, for example, to charge the device with gas. It is also conceivable that gas is removed by means of these borings. The recesses may also be equipped with valves, such as multiport valves.

A plurality of reaction chambers is located within the reactor element. In a further embodiment, the reactor element may be designed so that it consists of two parts. In this case, a reactor centerpiece whose outer shape is preferably disk-like, is embedded in a ring-shaped outer part of the reactor element. The individual reaction chambers are preferably isolated from each other by means of suitable sealing elements.

Such sealing elements are preferably all means of sealing that hold up under the reaction conditions present, characterized by, e.g., high temperature and high pressure. Possible examples of application are graphite seals, copper and/or lead seals.

The expression “channel” as used in this context refers to a connection between two openings that enable, for example, the penetration of a fluid through parts of the reactor element or through the entire reactor element. The channel can display a cross-sectional area that varies along the length of the channel or that can be, in a preferred embodiment, of a constant cross-sectional area. The cross-sectional area of the channel can be, for example, of an oval, round or polygonal outer contour, displaying straight or curved connections between the corner points of a polygon. However, a round or an equilateral polygonal cross-section is preferred. The channels can run straight and/or in curves, however, in a preferred embodiment, the channels are running along a straight equatorial axis.

The geometry of the reaction chambers can be described in the framework of “channels” as well. The reaction chambers as such are preferably connected to openings at the surface of the reactor element by vertical reaction channels that are adjacent to the reaction chambers. The reaction chambers are used in particular for accommodating the catalyst samples.

According to the invention, all channels of one segment are of the same geometry, in particular of the same cross-section and the same length. This helps to ensure the equipartition of the fluid flow of reaction gas. Only by implementing the same geometry for the channels branching off from a recess or from another channel is it possible to ensure that the reaction gas is equally distributed in the direction of the reaction chambers both with respect to the amount and to the flow rate of gas. It is therefore possible to define a specific level of pressure within the reactor element by means of geometry. In this context, the term “segment” refers to a part within the device according to the invention that contains a plurality of channels that connect the same elements, respectively. To ensure the equipartition of the fluid flow, the reaction chambers are equidistant with respect to the channels supplying them with reaction gas. These reaction gas supply channels are preferably oriented vertically and comprise, preferably, four horizontal channels that branch off and merge, for their part, into the reaction chamber. A plurality of reaction chambers that is arranged in the form of a matrix is the result of this equipartition of distances for the reaction chambers. The scenario of four channels of the same geometry branching off a channel of origin with the goal to achieve equipartition of the flow of fluids in all four channels that branch off, is referred to as a so-called quaternary system. Such a system is the preferred embodiment for supplying the reaction chambers with reaction gas.

According to the invention, the device contains an IR-transparent cover adjacent to one side of the reactor element. At the same time, this cover defines the boundary of the reaction chamber on the side that is opposite to the reaction channels. This IR-transparent cover is preferably disk-shaped and can also consist of several parts. Such embodiments involving several parts can also consist of a plurality of smaller covers. In principle, all materials that are transparent to IR-radiation are applicable, preferably, however, sapphire, zinc sulfide, barium difluoride, sodium chloride and/or silicon (e.g. Si wafers) are employed. It is possible, by virtue of this design of the device, to position the thermal camera outside of the device and thus isolated from adverse reaction conditions.

The device according to the invention contains at least one mask that is positioned between the reactor element and the IR-transparent cover and that displays uniform IR emissivity. Preferably, the mask is positioned in one of the recess areas of the reactor element. In case of a design of the reactor element in two parts, the centerpiece of the reactor is reduced in its thickness, preferably corresponding to the thickness of the mask, so that the overall thickness of reactor centerpiece and mask corresponds to the thickness of the outer, ring-shaped part of the reactor element.

In addition, there may be a provision for a disk-shaped element that is located between the mask and the reactor element and that improves the equipartition of the fluid flow.

To ensure a sufficient degree of sealing with respect to the fluid between reactor element, mask and IR-transparent cover, provisions may be made for additional IR-transparent seals between reactor element and mask and/or between mask and IR-transparent cover. With respect to the sealing material, reference is made to the materials discussed above in the context of isolating the reaction chambers against each other by means of sealing elements.

In principle, however, the mask can be made of all suitable materials that approximate the radiation properties of a black body and, as a consequence, do not introduce temperature artifacts due to differences in emissivity. Such materials are, for example, β-Si₃N₄ and graphite. According to the present invention, slate is used as the preferred material for the mask. The thermal radiation may be superimposed on the differences in temperature between the catalyst material and the surroundings and may therefore distort the measurements. In a preferred embodiment, the openings in the slate mask correspond to the openings in the reaction chamber in number, cross-section, and orientation. Preferably, the mask is located between the reaction chambers and the thermal camera. It is conceivable as well that several different thermal cameras are employed.

Preferably, the thermal camera consists of one or several IR thermal cameras, employed to determine the difference in temperature between active materials on the one hand and surrounding or inactive materials on the other hand, with spatial resolution. The results from the measurements taken with the thermal camera can then be analyzed, e.g., by means of a data processing unit or a computer, so that individual reaction chambers can be resolved. Preferably immediately afterwards, these chambers can then be subjected to further examining methods, such as mass spectrometry, gas chromatography, Raman spectroscopy or Fourier transform IR (FT-IR) spectroscopy, either individually or in combination of two or more of these methods. In the preferred embodiment, however, mass spectrometry and/or gas chromatography are applied. Additional meaningful combinations of methods of analysis are IR-thermography/GC-MS, IR-thermography/Raman spectroscopy, IR-thermography/dispersive FT-IR spectroscopy, color detection with chemical indicator/MS, color detection with chemical indicator/GC, color detection with chemical indicator/dispersive FT-IR spectroscopy, electronic or electrochemical sensors and many other more. Further details with respect to combining methods of analysis are given in the application DE-A 100 12 847.5. Using the data processing unit, it is furthermore possible to correct the results of the measurements for thermal background radiation occurring under reaction conditions. Details hereto are given in WO 99/34206.

A preferred embodiment of the inventive device is furthermore characterized in that the reactor element contains at lest two heating elements that are meander-shaped and arranged at an angle not equal to zero degrees relative to each other, with 90 degrees being the preferred angle. Additional embodiments in which pluralities of heating coils or heating capsules are arranged in helical, concentric or zigzag shapes are conceivable as well.

The reactor element of the inventive device is heated in a suitable manner by means of these heating elements. No restrictions are specified with respect to the design of the heating element so long as it ensures that the reactor element is heated sufficiently. The heating elements of the inventive device are preferably realized as electrical heating coils. However, the following embodiments are conceivable as well: channels that are fed by heated fluids and that are arranged corresponding to the heating elements or, e.g., heating capsules or active heat supply by means of heating elements that are attached outside of the reactor element. The heating elements can be fitted into the recesses directly at the reactor element or they can be part of the bottom plate that is attached to the surface of the reactor element with the surface displaying the openings for the reaction channels. The preferred material for manufacturing the bottom plate is brass.

Preferably, the heating elements are arranged in meander patterns on the bottom plate in between an array of recesses. Hereby, the recesses preferably correspond to the number of reaction chambers. Preferably, the heating elements are located in grooves of a, e.g., u-shaped cross-section. Provisions for these grooves are made on both sides, preferably only on one, in particular only on the side that is directed towards the reactor element. Preferably, the diameter of the groove is of a similar dimension as the heating elements so that the heating elements do not protrude above the surface of the bottom plate after they have been inserted into the grooves. Hereby, an even contact area is provided for attaching the bottom plate to the reactor element. In order to distribute the heat even more uniformly, the implementation of a heat distributor, for example in the shape of a thin disk between bottom plate and reactor element, is conceivable as well. The heat distributor is preferably directly attached to the side of the bottom plate that contains the heating elements and serves the purpose to evenly distribute heat emanating from the heating elements of the bottom plate onto the reaction chambers of the reactor element. In the preferred embodiment of using two heating elements, both heating elements are preferably arranged in one plane, with one heating element being rotated relative to the other element, preferably by 90 degrees. Here, energy supply for the heating elements is preferably realized from the side of the bottom plate.

The heat distributor is preferably disk-shaped, wherein its outer contour preferably corresponds to the centerpiece of the reactor, and it is attached adjacent to the centerpiece of the reactor. Thereby, the heat distributor borders on the one side to the middle part of the reactor and on the other side directly or indirectly, preferably directly, to the bottom plate. The heat distributor furthermore contains recesses that correspond, preferably, to the number, position and the orientation of the reaction channels that branch off vertically from the reaction chambers. These recesses preferably enable the throughput of reaction gases. Preferably, the heat distributor is made of a material of high thermal conductivity such as brass or copper.

Guiding elements for the reaction gas may be inserted into the reaction channels to achieve a well-defined flow of reaction gas. These elements can be, e.g., casings or jackets, preferably made of ceramic materials or stainless steel. The guiding elements for the reaction gas are partly or completely inserted into the reaction channels, reach through the exhaust element and the bottom plate, and protrude, preferably, into the exhaust chamber of the exhaust element. Thereby, the guiding elements prevent, in particular, a reaction of the product exhaust with the material of the heat distributor or with the bottom plate.

In a further embodiment of the reaction, the reaction gas is pre-heated to a specific temperature while the gas passes through the inlet port and the channels in the reactor element. Preferably, this temperature is in the range +/−50 Kelvin around the reaction temperature.

Hereby, it is also conceivable that the reaction gas flowing into the reactor element is already pre-heated and is brought up to reaction temperature within the reactor element or that it is brought to reaction temperature solely within the reaction element. The advantages of heating the reaction gas to reaction temperature within the reactor element are the following. First, unwanted reactions are avoided between the reaction gas and the materials with which it gets in contact on its way to the reaction chamber. Second, the heating of the reaction gas can be controlled by selecting the length of the gas inlet line with respect to the heating power of the heating elements, so that the reaction temperature is reached shortly before or on the reaction gas entering the reaction chamber. Thus, only the catalyst probe reacts with the reaction gas.

On the side of the bottom plate that is opposite to the heating elements, an optional exhaust element may be envisioned. It borders on one side to the bottom plate and enables the confluence of the individual reaction gas streams, resulting in one single exhaust stream. The exhaust element is preferably made of stainless steel, particularly preferred V2A or V4A steel. It also contains a matrix-type array of recesses that represent a continuation of the recesses in the bottom plate and that end in the exhaust element in a common exhaust chamber. The exhaust collected in the exhaust chamber is discharged, preferably, via a recess in the form of a through-hole out of the exhaust element.

According to the invention, the device contains an exhaust element with a plurality of membranes, as well as at least one movable sensor, such as a capillary, capillary system or a movable sensing element.

By using such a movable sensor, it is possible to selectively access the product gas flow (reaction gas emerging from the reaction chamber) of one individual reaction channel and to analyze the products with one or with several methods of analysis. Access is achieved by penetrating the membrane or, if several movable sensors are used, the membranes. Furthermore, direct access to the product gas flow by means of a sensor, without using a membrane, is conceivable as well if the sensor can be attached to an individual reaction channel in a gas-tight manner by other suitable means. In a still further embodiment, a plurality of sensors may be used simultaneously for a plurality of product gas streams. Based on the results of IR-thermography, the sensors can be positioned at the reaction channels that are connected to reaction chambers with particularly active catalysts to perform further analysis. The sensors are designed to allow for free positioning, preferably, in two dimensions but particularly preferred in three dimensions. To achieve an even more effective analysis of individual product gas streams, multiple capillaries may also be envisioned for the product exhaust from one reaction channel. Therewith, the product gas stream of one reaction channel can be investigated simultaneously with several different methods of analysis, such as mass spectrometry, gas chromatography, GCMS spectroscopy, Raman spectroscopy, Infrared spectroscopy, UV-VIS spectroscopy, NMR-, fluorescence- and ESR spectroscopy, NMR- and ESR tomography, and Moessbauer spectroscopy. Other sensible combinations of methods of analysis are IR thermography/GC-MS, IR thermography/Raman spectroscopy, IR thermography/dispersive FT-IR spectroscopy, color detection with chemical indicator/MS, color detection with chemical indicator/GC-MS, color detector with chemical indicator/dispersive FT-IR spectroscopy, analysis with electronic and electrochemical sensors and many others more.

The membranes can be designed as simple pinhole masks. Furthermore, the pinhole mask may be equipped with one or more septa or means for opening and closing individual holes, similar to, e.g., the iris of a camera. The material for the membranes can be, e.g., silicone or temperature resistant plastic materials such as Kapton.

In particular in conjunction with a simple pinhole mask, a pump may be planned that is used to create a negative pressure within the exhaust element, for example laterally or radially via a gas suction ring, thus ensuring that no reaction gas can leak into the environment in an uncontrolled manner.

To selectively analyze the gaseous substances flowing out of the respective reaction chambers, the device according to the invention may contain at least one multi-port valve.

By using one or several multi-port valves, it is possible, for example, to distribute the discharged product gas flow of a reaction channel among several devices of analysis. Also, the merging of selected product gas streams is easily possible this way. Thereby, the individual product gas streams flowing out of individual, several, or all reaction channels can be discharged separately and subsequently analyzed separately via a valve switch.

In a further embodiment, the device according to the invention may contain at least one geometrical constraint located at the gas inlet and outlet with the purpose of controlling the gas flow.

According to the invention, geometrical constraints refer to the tapering of the gas inlet and outlet channels either before and/or after the reaction chamber in order to ensure an ideal distribution of the gas flow. The individual geometrical constraints per gas inlet and/or gas outlet are preferably the same and have a pressure range Δp from 10⁻⁴ to 10² bar.

The device according to the invention is preferably employed for performing catalytic screening, in particular for analysis with IR thermography in combination with at least one additional method of analysis. Performing catalytic screening in this manner with two different methods of analysis is described, e.g., in DE-A 10012847.5. Reference is made hereto with respect to further details. Particularly preferred, the device is employed to screen heterogeneous catalysts that are part of a library of materials, in particular organometallic systems, organic compounds, such as pharmaceutical substances, polymers, composite materials, in particular such that are made of polymers and inorganic materials. Also, the method according to the invention can in principle be applied to all technical areas in which for mulations, i.e. compositions with more than one constituent, are produced and investigated with respect to their useful properties. Areas of application outside of materials research are, e.g., pharmaceutical formulations, formulations of food, nutritional supplements, feed, feed supplements as well as cosmetics products.

The expression “library of materials” used in the context of the subject invention relates to an array of at least two, preferably 10, further preferred 100, particularly preferred up to 1000, and even more preferred up to 100,000 modules that are localized in at least two different reaction chambers of the reaction element that are separated from each other.

Here, the expression “module” refers to a single defined unit that is located in one of the reaction chambers of the reaction element, with the reaction chambers being separated from each other. The unit may consist of one or of several components.

Preferably, the modules to be screened as defined above are made of non-gaseous materials, such as solids, liquids, sols, gels, paraffin-based substances or mixtures of substances, dispersions, emulsions, or suspensions, with solids being particularly preferred. The modules used in the context of the subject invention can be molecular or non-molecular chemical compounds, formulations or mixtures or materials. The expression “non-molecular” thereby refers to substances that can be altered or optimized continually and that stand, therefore, in contrast to “molecular” substances, whose structural expression can only be varied in discrete steps, such as by varying the pattern of substitution.

The modules of the combinatorial library of materials can be similar or dissimilar with respect to each other, with the latter being the preferred case. However, in the case of optimizing screening, reaction or process parameters, it may very well be the case that the library of substances contains two or more identical substances, or that the library in fact exclusively contains identical substances.

As far as the IR transparent cover is concerned, separating the plurality of reaction chambers from the thermal camera, a silicon wafer or a sapphire disk is utilized in the particularly preferred embodiment.

By using the device according to the invention (reactor), it is possible to simultaneously apply two or more methods of analysis for the screening of a library of catalysts. The methods of analysis include, for example, thermography combined with an additional method, such as mass spectrometry. Thereby, it is possible to charge each reaction channel with reaction gas separately and without cross-talk between individual channels. Therefore, by using the device according to the invention, it is possible to rapidly identify active components, such as catalysts, by means of a thermal camera and, in a second step, to selectively determine and to quantify the products contained in the discharge of these components, e.g. catalysts, by means of, e.g., mass spectrometry or gas chromatography.

Therefore, much more catalysts can be screened in a much shorter time interval than has been possible with the methods and devices disclosed previously.

An embodiment of the subject invention is now explained in detail by means of the enclosed drawings.

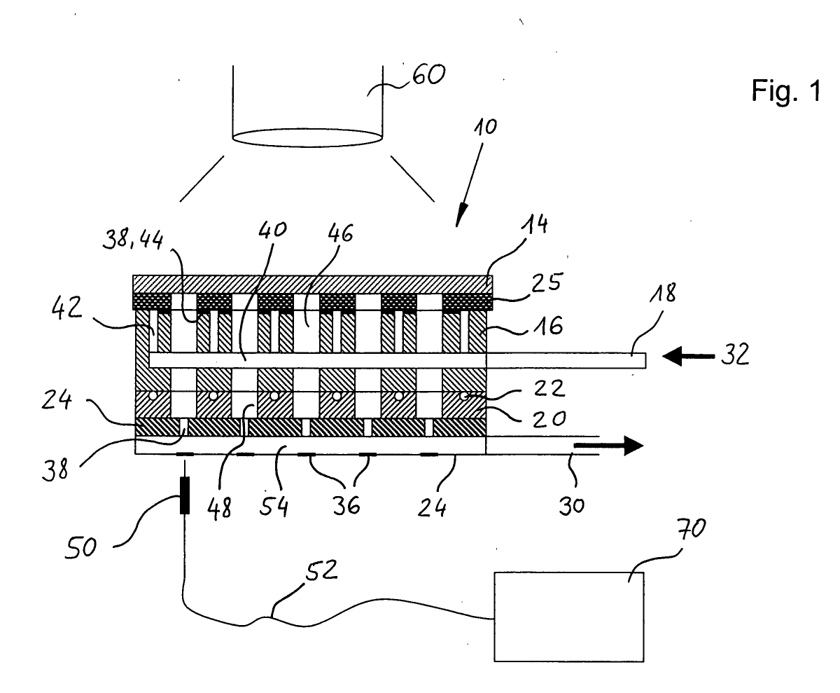

FIG. 1: Schematic representation of an embodiment of the device according to the invention, showing a cross-sectional side view.

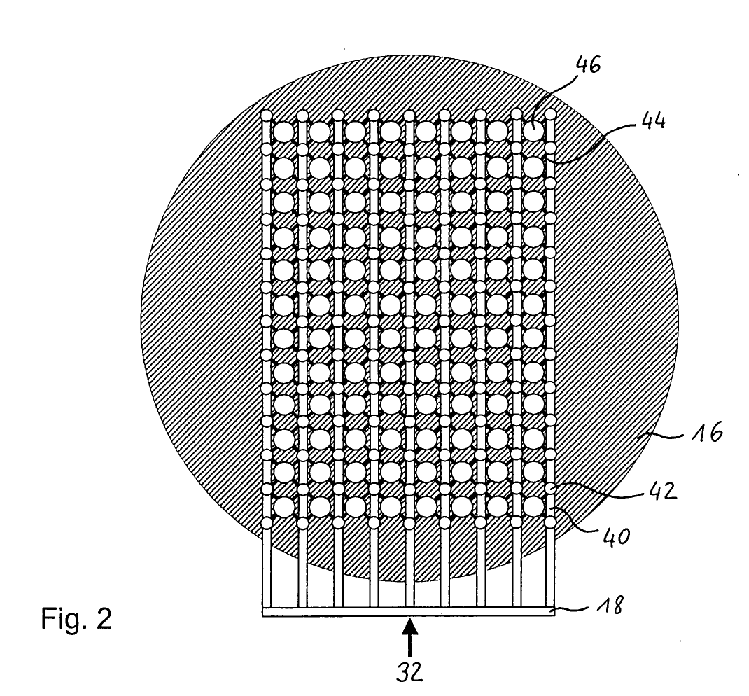

FIG. 2: Schematic representation of the reactor element.

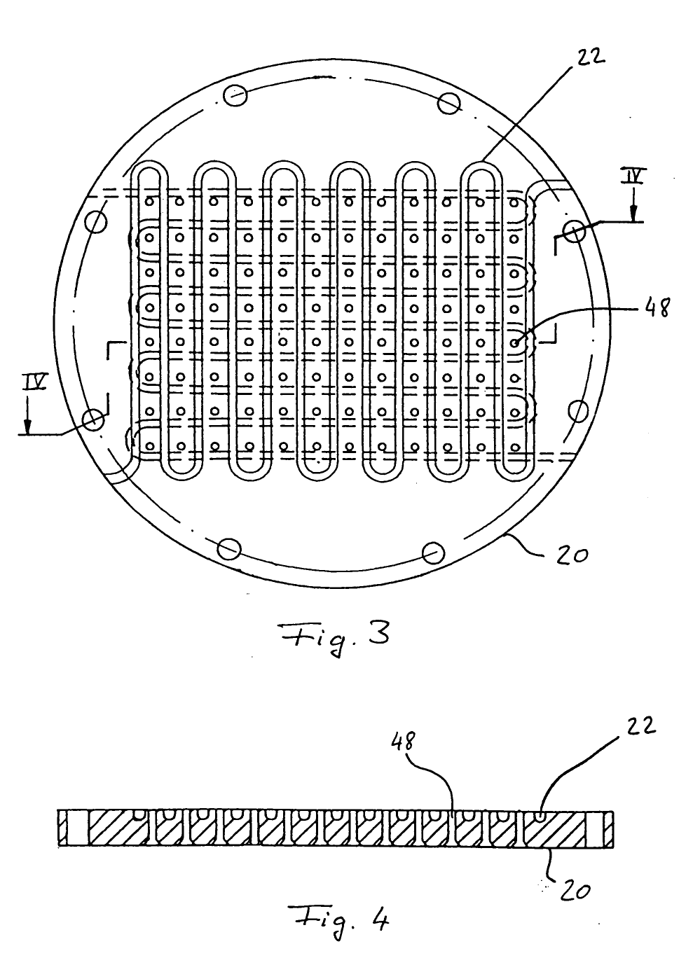

FIG. 3: Schematic representation of the arrangement of heating elements.

FIG. 4: Cross-sectional view along the line IV-IV shown in FIG. 3.

FIG. 1 shows a device 10 for performing the screening of catalysts. The device enables complete access to the catalyst samples under reaction conditions by means of a thermal camera while simultaneously, completely and physically shielding the environment from the reaction gas. The shielding contains most of the thermal radiation emanating from the device material and distorting the temperature differences between the catalyst material and the environment.

The embodiment of the inventive device 10 shown in FIG. 1 contains a Silicon wafer 14, a slate mask 25, a reactor element 16 with a gas inlet port 18, a bottom plate 20 with a heating element 22, as well as an exhaust element 24.

Cohesion between the individual elements can be achieved, e.g., by means of clamping elements and/or fasteners (not shown). The clamping elements are preferably realized as ring-shaped rotatable devices, where e.g. an upper clamping element holds the IR-transparent cover in place on the one side of the device while, e.g., a lower clamping element is located on the other side, which is preferably designed to hold the fastening elements. No particular restrictions are specified with respect to the material of the clamping/fastening elements according to the invention, so long as the materials are capable of withstanding the stress that they are exposed to. Preferably, metals or metallic alloys are employed, such as brass, aluminum and stainless steel, e.g. stainless steel according to DIN 14401, DIN 14435, DIN 14541, DIN 14571, DIN 14573, DIN 14575, DIN 24360/24366, DIN 24615/24617, DIN 24800/24810, DIN 24816, DIN 24851, DIN 24856, DIN 24858, DIN 14767, DIN 24610, DIN 14765, DIN 14847, DIN 14301. V2A or V4A steel are particularly preferred. The use of ceramic materials is conceivable as well. Both clamping elements contain recesses, preferably realized as through-holes, that are used to accommodate the fastening/connecting elements.

The upper clamping element particularly serves the purpose of holding an IR-transparent material in place and is preferably realized as a disk. The selection of materials for this disk is not restricted, so long as the materials can be manufactured to provide the desired dimensions and are transparent to infrared radiation. The disk, preferably a silicon wafer, has, according to the invention, the particular purpose of serving as an IR-transparent window. Hereby, other materials may be used as well, such as sapphire, zinc sulfide, barium difluoride, sodium chloride, Al₂O₃, CaF₂, Ge, Si, GaAs, CdTe, ZnSe, quartz glass, KRS-S, IKS materials, as well as IG materials. However, sapphire and, particularly preferred, silicon are the preferred materials. It is also conceivable to employ any combination of the aforementioned materials. In a particularly preferred embodiment, the disk is a silicon wafer and borders on the one side to the upper clamping element and on the other side to the reactor element.

The upper clamping element that is envisioned as an optional element of the device can furthermore serve, for example, as a sealing device and/or it can prevent unwanted IR-reflections, which may occur at certain positions of the thermal camera, by means of angling/slanting. By selecting such embodiments, adverse effects such as back coupling can be avoided.

The lower clamping element positioned on the side opposite to the upper clamping element terminates the device. The lower clamping element is connected to the exhaust element and establishes, in combination with the upper clamping element, the gas-tight cohesion of all elements in between. The cohesion is preferably realized by means of screw connections. The tightness of the individual elements with respect to each other is achieved by flush contact between polished surfaces; if necessary, additional tightening can be achieved by means of a graphite foil. The function ascribed to the lower clamping element can also be performed by the exhaust element, with the main functions of the lower clamping element being integrated into the exhaust element.

The main function of the lower clamping element is to hold the exhaust element in place and to, if necessary, contain elements of the analytical devices. Furthermore, another function may be to hold the other elements of the device together, in combination with the upper clamping element.

The lower clamping element, being an optional element just like the upper clamping element, may furthermore serve as a sealing element, for gas suction (e.g. radial gas suction), as a capillary guiding element as well as for positioning a pattern for image recognition of, for example, the individual holes.

The preferred fastening elements are nuts and bolts. Alternatively, other clamping elements may be employed, such as spring clamps, or fastening elements that are part of the preferably ring-shaped components, for example bayonet locks. An other possibility to connect the individual components is to press all components against each other in a dedicated rack.

As shown in FIG. 1 as well, the reaction gas 32 is supplied to the device 10 preferably from the side via a gas inlet port 18 and the adjacent recesses 40 that are preferably horizontal, inside the reactor element 16. The horizontal recesses 40 are preferably a part of the gas inlet port 18 since the gas inlet port 18 and the horizontal recesses 40 can only be part of different reactor elements if the embodiment consists of several parts. The reaction gas 32 flows through the horizontal recesses 40 of the reactor element 16 into the channels 42 branching off vertically therefrom, continuing on into the horizontal channels 44 that branch off the vertical channels 42, all the way into the reaction chambers 46. Assuming the proper geometry, it is also conceivable that the channels 42 and 44 are merged into one channel that may be directed bow-shaped or diagonally. The reaction gas reacts with the catalyst samples in the reaction chamber, and afterwards it flows from the reaction chambers 46 into the reaction channels 48. These originate from the reaction chambers 46 and are directed vertically towards the exhaust element 24. Originating therefrom, the reaction gas 32 flows into the recesses of the bottom plate 20 including the casings or jackets made of an inert material, continuing on through these into the recesses of the exhaust element 24 und therefrom, finally, into the exhaust chamber 54. The reaction gas 32 (product exhaust) is collected therein and actively directed out of the exhaust element 24 in form of exhaust 34, preferably to the side through a gas outlet port 30. The horizontal channels 44 as well as the recesses in the exhaust element 24 function as the preferred realization of geometrical constraints 38, preferably by being tapered. This allows for controlling the gas flow.

Furthermore, the exhaust element 24 contains membranes 36, which can be penetrated by a capillary 50 that can be moved to any desired position. Here, the moveable capillary 50 is the preferred embodiment of a sensor, thus allowing to access the product outlet flow of one reaction channel 48 selectively. The moveable capillary 50 is connected to the unit of analysis 70 by means of connecting lines 52. This unit of analysis 70 can contain one analytical device as well as a plurality of analytical devices, such as a combination of mass spectrometer and gas chromatograph. The connecting lines 52 are preferably realized as tubes, hoses made of, e.g., kapton, PE capillaries, glass capillaries and or quartz capillaries, which have the function to guide the product outlet flow, or parts thereof, to the unit of analysis 70. A bundle of capillaries may also be envisioned as a connecting line 52, guiding the product outlet flow from one or several moveable capillaries 50, or parts thereof, to a plurality of units of analysis. Furthermore, it is conceivable that not only several individual moveable capillaries 50 are envisioned, but that one moveable capillary 50 contains a capillary bundle, with the capillaries within the capillary bundle of the moveable capillary 50 being connected by a connecting line 52 that is realized as a capillary bundle, too. This ensures that the exhaust is divided among the individual capillaries of the bundle and directed, preferably, towards the different units of analysis, respectively. Thereby and preferably, one capillary of the capillary bundle is connected to one corresponding unit of analysis.

The moveable capillary 50 is preferably connected to a unit of control (not shown in FIG. 1) that in turn is connected to a data processing unit or a computer (not shown in FIG. 1). This data processing unit processes the results from the measurement with, preferably, a thermal camera 60 and moves correspondingly by using the unit of control, the moveable capillary 50 to these reaction channels 48 that are connected to reaction chambers 46 that in turn contain active catalysts as identified by the thermal camera 60. Therefore, effective screening is enabled by means of further analyzing only the product flow from active catalysts. The effectiveness can be enhanced even more, for example, by employing a plurality of moveable capillaries 50 or by parallel analysis using a plurality of methods of analysis. Furthermore, it is conceivable that a plurality of thermal cameras 60 is employed thus achieving an even finer resolution of the temperature gradient between catalyst material on the one hand and surrounding or inactive materials on the other.

As is furthermore visible in FIG. 1, a slate mask 25 pointed in the direction of the thermal camera 60 covers the reactor element 16. The preferred purpose of this slate mask 25 is to prevent temperature artifacts due to differences in emissivity that are mostly caused by the heating up of elements of the device. This unwanted thermal radiation could distort the desired measurement of the temperature difference between the catalyst material on the one hand and surrounding or inactive materials on the other hand in an interference effect.

A silicon wafer 14 covers the slate mask 25, preferably pointed in the direction of the thermal camera 60 and serves as an IR-transparent window.

FIG. 2 shows the flow of the reaction gas within the reactor element 16 with respect to the point of view 11-11 shown in FIG. 1. It can be seen that the reaction gas 32 flows into the reactor element 16, preferably through parallel horizontal recesses 40, therefrom the gas flows into the vertical channels 42 and finally through the horizontal channels 44 into the reaction chambers 46.

In the case of an embodiment of the reactor element in two parts, the centerpiece of the reactor contains recesses in the horizontal direction that can be arranged in between the rows of reaction chambers 46, just as was the case for the one-piece reactor element 16. If the centerpiece of the reactor is fitted into the outer, ring-shaped part of the reactor element, these recesses lie in the same plane and are of the same direction (in the vanishing line) and, preferably, of the same diameter as the through holes that are envisioned to be in the outer, ring-shaped part of the reactor element and used for gas supply. Therefore, the gas can flow through the boreholes of the outer, ring-shaped part of the reactor element into the recesses, preferably blind holes, of the centerpiece of the reactor. Sufficient gas tightness between the two elements, without implementing additional sealing devices, can be achieved by selecting proper shape and tolerances for the outer dimensions of the centerpiece of the reactor and the inner dimensions of the outer, ring-shaped part of the reactor element.

Within the device 10, channels 42 branch off vertically from the horizontal recesses 40. These vertical channels 42, which branch off from the horizontal recesses 40 within the centerpiece of the reactor in the case of the embodiment of the reactor in two parts, end preferably just short of underneath the mask that forms the black body, preferably realized as a slate mask 25. Horizontal channels 44 then branch off the vertical channels 42, with the horizontal channels being connected with one corresponding reaction chamber 46. Therewith, each individual reaction chamber 46 can be charged with reaction gas 32 from all sides or only from a part of the sides, with charging from four sides being the preferred embodiment.

In order to achieve equipartition of the gas, in particular equipartition of the gas flow, all channels branching off from a recess or a channel, respectively, are of the same geometry (with respect to cross-section and length).

The design of the reactor element as shown in FIGS. 1 and 2 ensures separate charging of each reaction chamber 46 with reaction gas 32 without crossing-over (back diffusion of reaction gas 32 from one reaction chamber 46 into another).

A preferred arrangement of two heating elements 22 in the bottom plate of device (10) is shown in FIG. 3, with the heating elements being arranged meander-shaped at an angle of 90 degrees relative to each other. This arrangement enables the targeted heating of the reactor element 16 close to the reaction chambers 46 while simultaneously allowing for guiding the product outlet flow of each reaction chamber 46 right through the heating elements 22 by means of the reaction channels 48.

Finally, the bottom plate shown in FIG. 3 is shown in a cross-sectional view in FIG. 4.

Referene list:

10 inventive device

14 silicon wafer

16 reactor element

18 gas inlet port

20 bottom plate

22 heating element

24 exhaust element

25 slate mask

30 gas outlet port

32 reaction gas

34 exhaust

36 membrane

38 geometrical constraint

40 horizontal recess

42 vertical channel

44 horizontal channel

46 reaction chamber

48 reaction channel

50 moveable capillary

52 connecting lines

54 exhaust chamber

60 thermal camera

70 unit of analysis

1. Device (10), in particular for performing catalytic screening, containing a reactor element (16) with at least one gas inlet port (18) and a plurality of channels (42,44) as well as a plurality of reaction chambers (46) that are connected with the channels (42,44), characterized in that the channels (42,44) form an angle not equal to zero degrees with the, at least one, gas inlet port (18).

2. Device (10) according to claim 1, characterized in that all channels of a segment have the same geometry, in particular the same cross-section and the same length.

3. Device (10) according to claims 1 or 2, characterized in that the reaction chambers (46) are terminated on one side by at least one cover that is transparent to infrared radiation (14).

4. Device (10) according to any of the preceding claims, characterized in that it contains at least one mask (25) characterized by uniform IR emissivity.

5. Device (10) according to any of the preceding claims, characterized in that the reactor element (16) contains at least two heating elements (22) that are arranged in meander shapes and at angles not equal to zero degrees with respect to each other.

6. Device (10) according to claim 5, characterized in that the angle is 90 degrees.

7. Device (10) according to any of the preceding claims, characterized in that the reaction gas (32) is pre-heated to a defined temperature while flowing through the gas inlet port (18) and the channels (42,44) in the reactor element (16).

8. Device (10) according to claim 7, characterized in that the temperature is in the range of +/−50 Kelvin of the reaction temperature.

9. Device (10) according to any of the preceding claims, characterized in that it contains an exhaust element (24) with a plurality of membranes.

10. Device (10) according to any of the preceding claims, characterized in that it contains at least one moveable sensor (50).

11. Device (10) according to any of the preceding claims characterized in that it contains at least one multi-port valve for the selective analysis of the gaseous substances from the respective reaction chambers.

12. Device (10) according to any of the preceding claims characterized in that gas inlet (18) and gas outlet (30) port contain at least one geometrical constraint (38) for controlling the gas flow.

13. Use of a device (10) according to any of the claims 1 to 12 for the performance of catalytic screening of modules of a library of materials, in particular for the analysis by means of infrared thermography combined with at least one further method of analysis.

14. Use of a silicon wafer (14) to cover the plurality of reaction chambers (46) with respect to a thermal camera (60).
